(19) United States
(12) Patent Application Publication
(10) Pub. No.: US 2026/0098444 A1
(43) Pub. Date: Apr. 9, 2026

(54) ROLL-UP AUXILIARY DEVICE FOR BLIND

(71) Applicant: ALL WANG LIMITED, Taipei (TW)

(72) Inventors: Chih-Yung WANG, Taipei (TW); Chao-Ying CHEN, Pingtung County (TW)

(21) Appl. No.: 18/905,891

(22) Filed: Oct. 3, 2024

(51) Int. Cl. E06B 9/42; E06B 9/78

(52) U.S. Cl. CPC E06B 9/42; E06B 9/78

(57) ABSTRACT

A roll-up auxiliary device includes a main body; at least one first torque spring, sleeved on the main body; a transmission body, sleeved on the at least one first torque spring and engaged with the at least one first torque spring, and the transmission body disposed with a shaft rod; at least one second torque spring, sleeved on the shaft rod; a drive body, for accommodating the shaft rod and engaged with the at least one second torque spring; an axial cover, sleeved on the shaft rod and abutting the drive body; and two fasteners, fixed on two sides of the transmission body, respectively. A first resistance of the at least one first torque spring during pulling down is larger than a second resistance of the at least one second torque spring during pulling up, such that a balance of pulling up and down is improved.

### FIELD OF THE INVENTION

The invention relates to a roll-up auxiliary device, and more particularly to a roll-up auxiliary device for positioning a blind during pull-up and pull-down.

### BACKGROUND OF THE INVENTION

Please refer to FIG. 1. An existing blind 1 includes an upper rail 10 fixed above the window; a tubular body 101; a roll-up device 11 disposed at one end within the tubular body 101 and including an torque-accumulating roller spring 111; a resistance device 12 disposed inside the tubular body 101 opposite to one end of the roll-up device 11; two fixed brackets 13 respectively provided for the roll-up device 11 and the resistance device 12 axially connected and fixed to two sides of the upper rail 10; a lower rail 14 disposed below the upper rail 10 at an interval; and a blind fabric 15; wherein one of the two fixed brackets 13 is provided with an adjustment wheel 131 axially connected to the roll-up device 11.

When installation of the blind 1, the adjustment wheel 131 is firstly used for adjusting the torque-accumulating roller spring 111 to be rotated to a preset number of turns, such as ten turns, and then a torque force accumulated by the torque-accumulating roller spring 111 reaches balance in conjunction with the resistance device 12.

Please further refer to FIG. 2 and FIG. 3. The resistance device 12 includes a main body 121, at least one spring 122, a transmission body 123, and a driving body 124. One side of the main body 121 is provided with a protruding fitting portion 1211 and a protruding portion 1212 connected to one end of the protruding fitting portion 1211. In this embodiment, a number of the at least one spring 122 is two, and the two springs 122 are disposed side by side and are sleeved on the protruding portion 1212 of the main body 121. A first protrusion 1221 is disposed at one end of each of the two springs 122, and a second protrusion 1222 is disposed at the other end of each of the two springs 122, respectively. The transmission body 123 is sleeved on the two springs 122, two first protrusions 1221 and two second protrusions 1222 of the two springs 122 are engaged with a slot 1231 of the transmission body 123. One side of the transmission body 123 is provided with a shaft rod 1232. The driving body 124 is sleeved on one end of the shaft rod 1232 and is engaged with the tubular body 101.

Please refer to FIG. 1 and FIG. 3. During operation, by pulling down or pulling up the lower rail 14 with a hand, the blind fabric 15 can be extended downward by the applied force or be retracted upward by the torque force accumulated in the torque-accumulating roller spring 111, the tubular body 101 drives the driving body 124 of the resistance device 12 to rotate together, and the driving body 124 further drives the transmission body 123 to push the two first protrusions 1221 or the two second protrusions 1222 of the two springs 122 via the slot 1231, thereby tightening the two springs 122 against the protruding portion 1212 of the main body 121 to increase resistance. Consequently, equal resistance is provided during both the downward and upward movements of the blind fabric 15, thereby achieving balance through the resistance device 12. At the stage, the torque force accumulated in the torque-accumulating roller spring 111 will vary in accordance with the movement of the blind fabric 15. When a user releases the hand at the desired height, the blind 1 returns to a balanced state, allowing the blind fabric 15 to be positioned immediately.

Please refer to FIG. 1 and FIG. 4. The torque force accumulated in the torque-accumulating roller spring 111 has a limit of safe operational turns, for example eighty turns, in which the maximum length of the blind fabric 15 that can be borne is seventy turns. If the length of the blind fabric 15 is longer, such as seventy-five turns, operational turns of the torque-accumulating roller spring 111 will reach eighty-five turns when the blind fabric 15 is fully extended. Alternatively, if the blind fabric 15 is made of heavier material, the preset number of turns may need to be increased up to fifteen turns during installation, and in this case, when the blind fabric 15 is fully extended, the operational turns of the torque-accumulating roller spring 111 will also reach eighty-five turns. Although both scenarios allow the blind fabric 15 to be stretched and retracted, prolonged operation beyond eighty turns for the torque-accumulating roller spring 111 will lead to elastic fatigue and damage thereof, failing smooth retraction and shortening its lifespan. Therefore, further improvements are necessary.

### SUMMARY OF THE INVENTION

A main object of the invention is to solve the problem that elastic fatigue in a torque-accumulating roller spring of a blind, which is easily caused by an increase in the length or weight of the fabric of the blind, ultimately leading to a shortened lifespan of the torque-accumulating roller spring.

In order to achieve the above object, the invention provides a roll-up auxiliary device, for positioning a blind during pulling up or pulling down, including a main body; at least one first torque spring sleeved on a first side of the main body; a transmission body, sleeved on the first side of the main body as the at least one first torque spring and sleeved on the at least one first torque spring, a first protruding end of the at least one first torque spring engaged with the transmission body, and a first side of the transmission body disposed with a shaft rod; a at least one second torque spring, sleeved on the shaft rod; a drive body, for accommodating the shaft rod therein and engaged with a second protruding end of the at least one second torque spring; an axial cover, sleeved on an end of the shaft rod and abutting the drive body; and two fasteners, fixed on the axial cover and the first side of the transmission body, and fixed on a second side of the transmission body, respectively; wherein, during pulling down the blind, the at least one second torque spring is tightened on the shaft rod to drive the transmission body to rotate, the transmission body drives and loosens the at least one first torque spring to rotate on the main body with a first resistance, and the first resistance is utilized as a balance for stop pulling down the blind, and during pulling up the blind, the at least one second torque spring is loosened to rotate on the shaft rod, the transmission body tightens the at least one first torque spring on the main body, such that the transmission body do not rotate, the at least one second torque spring rotates on the shaft rod with a second resistance, and the second resistance is smaller than the first resistance to facilitate pulling up the blind.

In some embodiments, the main body comprises a flange portion, a first protrusion, and a second protrusion, the first protrusion and the second protrusion are respectively disposed at two sides of the flange portion and opposite to each other, the first protrusion comprises a first chamber, the second protrusion comprises a second chamber, a step portion is connected between the flange portion and the first protrusion, and the step portion comprises an axial hole communicating with the first chamber and the second chamber.

In some embodiments, the at least one first torque spring is sleeved on the first protrusion at the first side of the main body.

In some embodiments, a number of the at least one first torque spring is two, the two first torque springs are disposed side by side.

In some embodiments, the transmission body further comprises a sleeving portion at the second side of the transmission body and sleeved on the step portion, the sleeving portion comprises an inner space and a first slot on a peripheral of the sleeving portion, a protruding shaft is disposed in the inner space, the inner space is provided for accommodating the first protrusion and the first torque spring, the protruding shaft is a circular shaft and penetrates through the axial hole of the step portion, one of the two fasteners penetrates through the second chamber and fixed on the protruding shaft, and the first slot of the sleeving portion is engaged with the first protruding end of the at least one first torque spring.

In some embodiments, the shaft rod comprises a first rod portion, a second rod portion connected with the first rod portion, and a third rod portion connected with the second rod portion, the first rod portion and the second rod portion are circular rods, an outer diameter of the second rod portion is larger than an outer diameter of the first rod portion, and the third rod portion is a hexagonal rod.

In some embodiments, the at least one second torque spring is sleeved on the second rod portion of the shaft rod.

In some embodiments, the drive body comprises a bushing portion and at least one positioning slot, the bushing portion comprises an accommodating space, an inner abutting wall at a bottom of the accommodating space, and a through hole, the accommodating space is provided for accommodating the second rod portion and the at least one second torque spring, the inner abutting wall abuts the at least one second torque spring, the through hole communicates with the accommodating space for the second rod portion of the shaft rod to penetrate therethrough, an outer peripheral of the bushing portion is provided with a second slot, and the second slot is engaged with the second protruding end of the at least one second torque spring.

In some embodiments, the axial cover comprises a cover flange and a cap connected to the cover flange, the cover flange and the cap comprises a hexagonal hole therein, the hexagonal hole is engaged with the third rod portion, the cap is hexagonal, an outer diameter of the cap is smaller than an outer diameter of the cover flange, the cap comprises a hole communicating with the hexagonal hole, an inner diameter of the hole is smaller than an inner diameter of the hexagonal hole, one of the two fasteners penetrates through the hole of the cap and is fixed on the third rod portion of the shaft rod, and the axial cover abuts the drive body.

In some embodiments, a ratio of the first resistance to the second resistance is in a range from 6:4 to 8:2.

Through the foregoing implementation of the invention, compared with the prior art, the invention has the following characteristics: the roll-up auxiliary device is utilized for positioning the blind during pulling up or pulling down, the at least one second torque spring rotating on the shaft rod with the second resistance is smaller than the at least one first torque spring rotating on the main body with the first resistance when pulling down the blind, to maintain a balance for pulling up and pulling down the blind. In the event of an increase in the length or weight of the fabric of the blind, the torque-accumulating roller spring is less likely to exceed its optimal number of working turns, allowing it to support the loner or heavier fabric while preventing the at least one torque spring from accelerating damage due to elastic fatigue, thereby extending its lifespan.

### BRIEF DESCRIPTION OF THE DRAWINGS

FIG. 1 is a three-dimensional exploded view of an existing blind and a resistance device.

FIG. 2 is a three-dimensional exploded view of the resistance device in FIG. 1.

FIG. 3 is a schematic diagram of an action of the resistance device in FIG. 1.

FIG. 4 is a schematic diagram of the blind in FIG. 1 due to elastic fatigue damage and failure to retract smoothly.

FIG. 5 is a three-dimensional exploded view of a configuration of a blind and a roll-up auxiliary device of the invention.

FIG. 6 is a three-dimensional exploded view of the roll-up auxiliary device of FIG. 5.

FIG. 7 is a three-dimensional exploded view of the roll-up auxiliary device of FIG. 6 from another angle.

FIG. 8 is a cross-sectional view of combination of the roll-up auxiliary device of the invention.

FIG. 9A is a schematic diagram of pulling a blind fabric downward of the present invention.

FIG. 9B is a schematic diagram of an action of the roll-up auxiliary device in FIG. 9A in a stretched state.

FIG. 10A is a schematic diagram of pulling the blind fabric up of the present invention.

FIG. 10B is a schematic diagram of a pulling action of the roll-up auxiliary device in FIG. 10A.

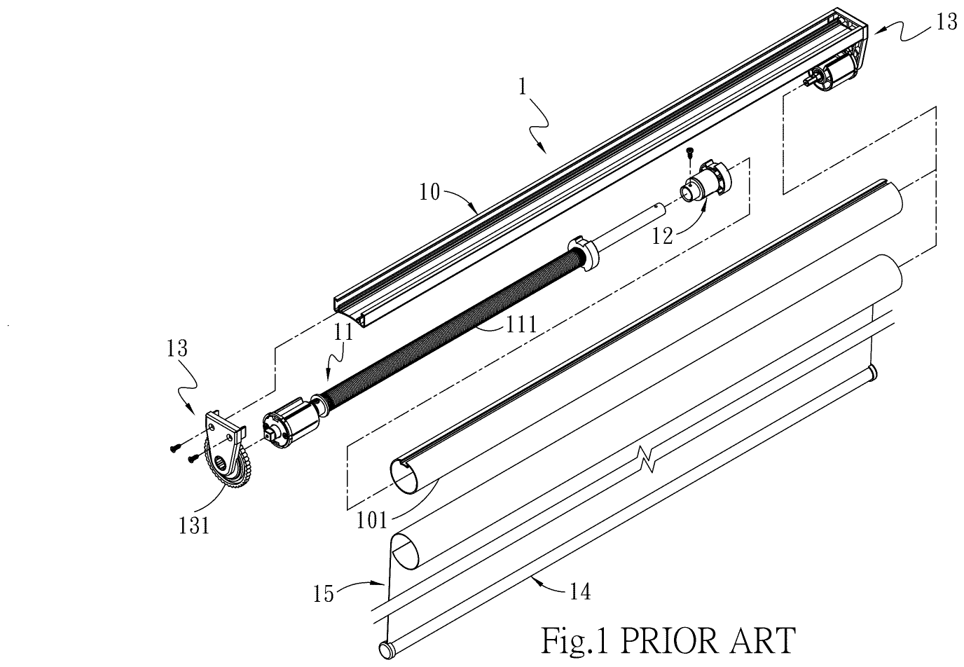

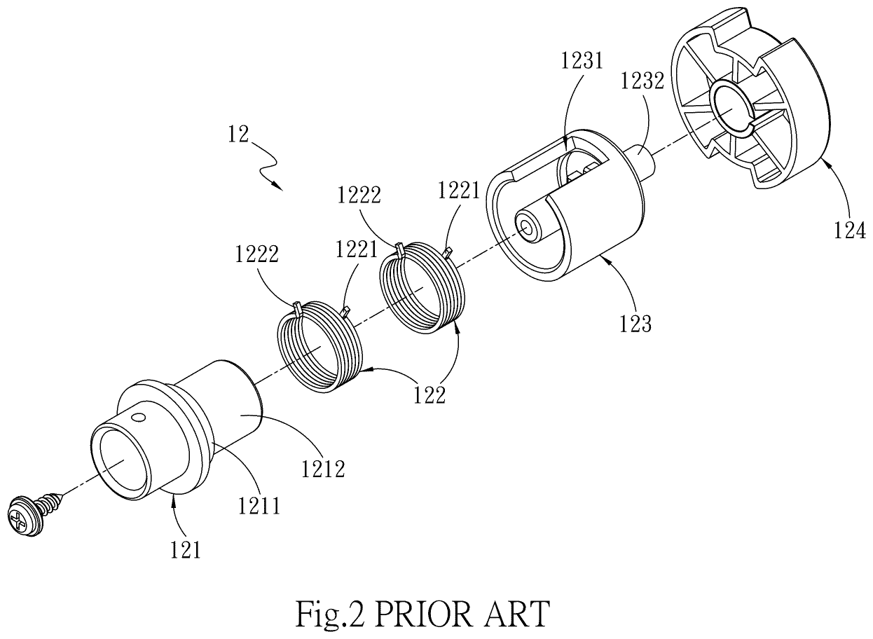

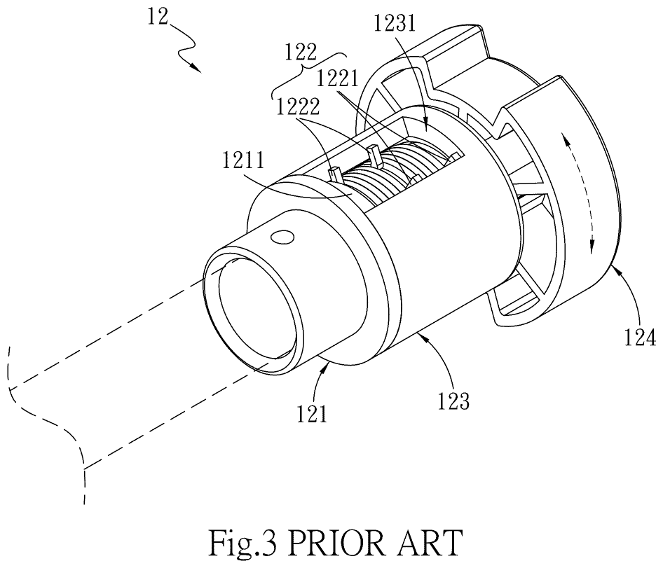

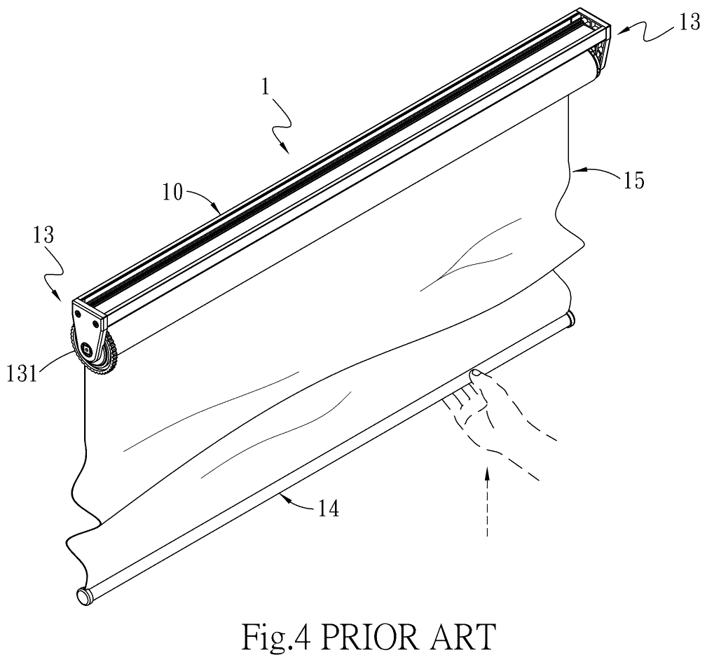

### DETAILED DESCRIPTION OF THE PREFERRED EMBODIMENTS

The detailed description and technical content of the invention are described below with reference to the accompanying drawings.

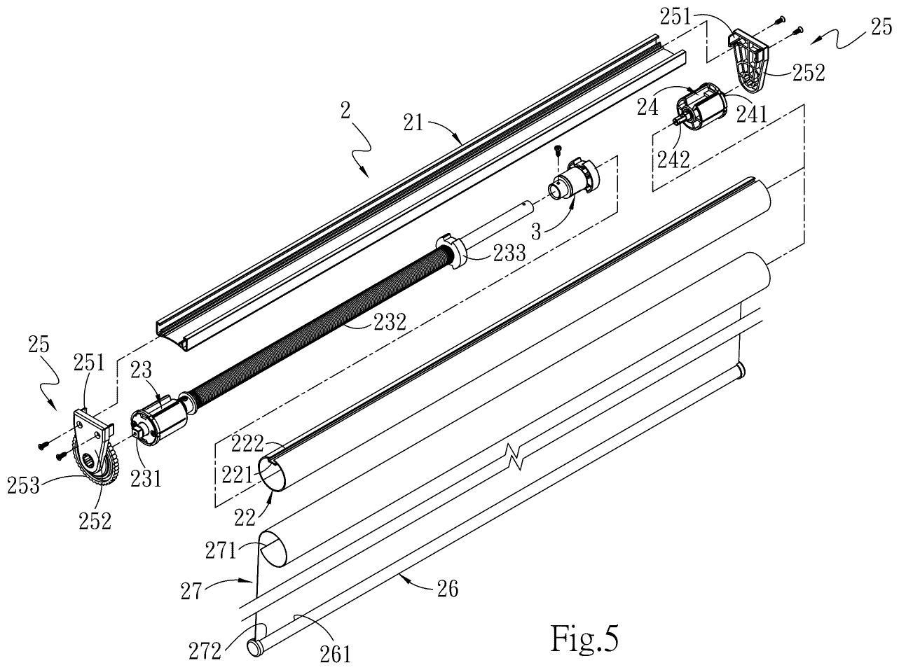

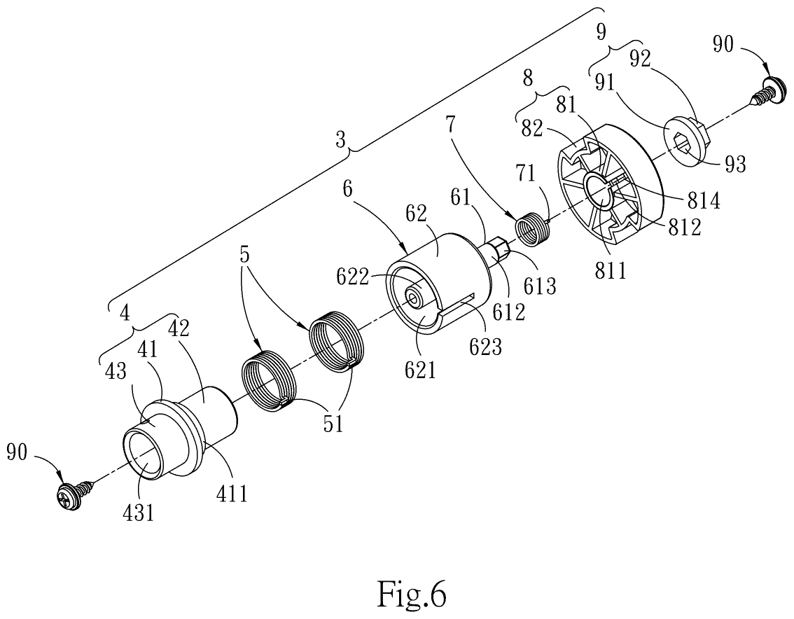

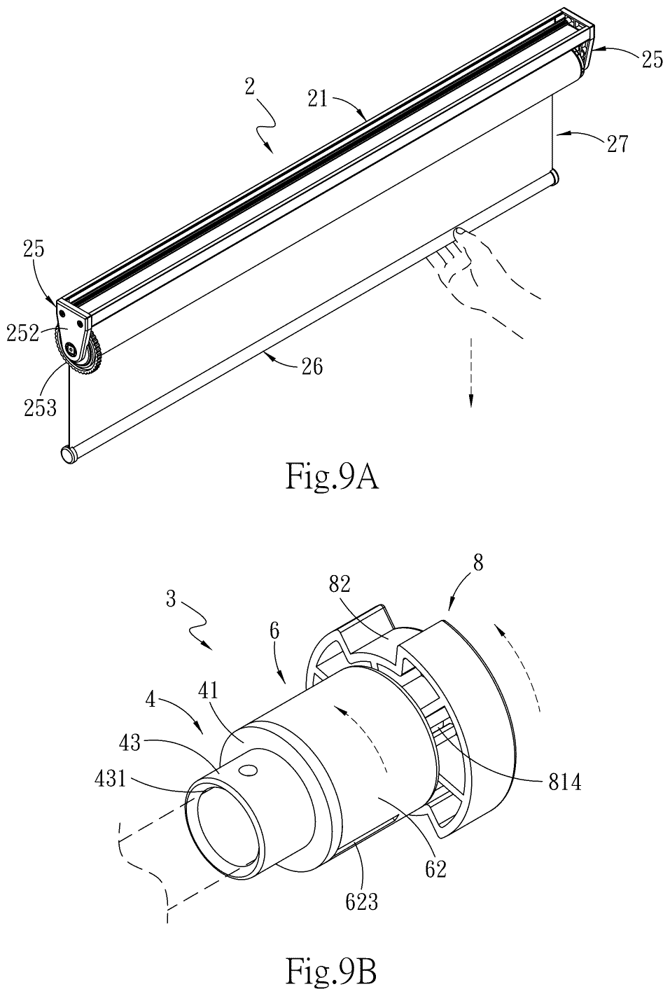

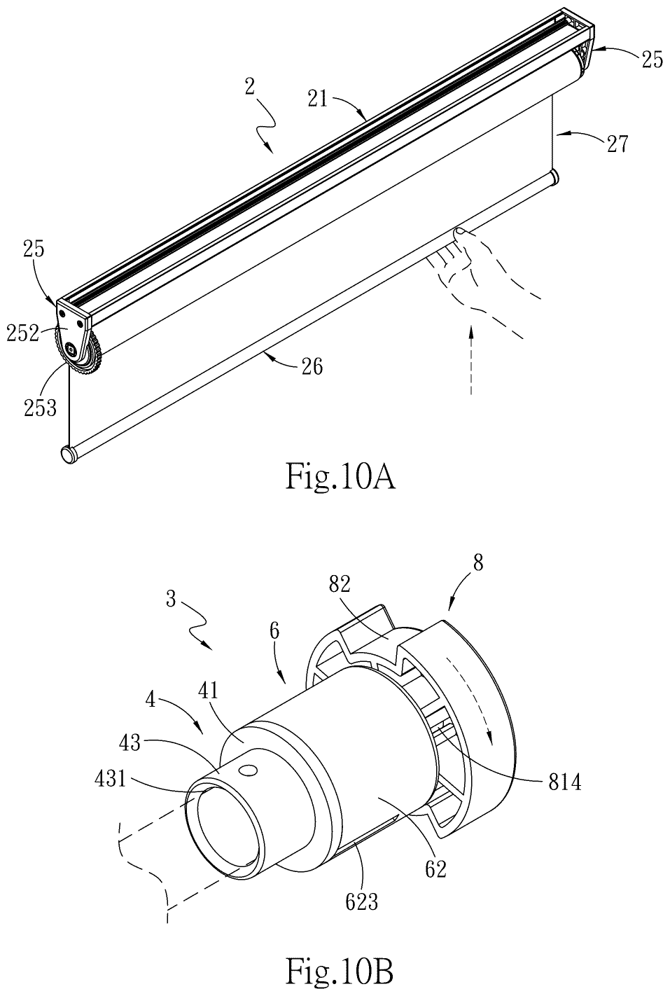

Please refer to FIG. 5, FIG. 6, FIG. 9A, and FIG. 10A. The invention provides a roll-up auxiliary device 3 for positioning a blind 2 during pulling up or pulling down. The blind 2 includes an upper rail 21, a tubular body 22, a roll-up device 23 disposed inside one end of the tubular body 22, a roll-up control device 24 disposed inside the other end of the tubular body 22 and opposite to the roll-up device 23, two fixed brackets 25 respectively disposed and fixed to two sides of the upper rail 21, a lower rail 26 disposed below the upper rail 21 at intervals, and a blind fabric 27. The roll-up auxiliary device 3 is disposed inside the tubular body 22 and axially connected to the roll-up device 23 at one end and the roll-up control device 24 at the other end. The tubular body 22 is provided with a limiting protrusion 221 for assembling and fixing the roll-up device 23, the roll-up auxiliary device 3, and the roll-up control device 24. An embedding groove 222 is provided above the limiting protrusion 221 for one end 271 of the blind fabric 27 to be embedded, so that the blind fabric is wound around an outer surface of the tubular body 22, enabling the blind fabric 27 to be up and down by being driven by the tubular body 22. A surface of the lower rail 26 is provided with a channel 261 for an other end 272 of the blind fabric 27 to be placed into and fixed.

The roll-up device 23 is located at one end of the upper rail 21, one end of the roll-up device 23 is provided with a fixing column 231 in a square shape, the fixing column 231 is axially connected to one of the two fixed brackets 25, the other end of the roll-up device 23 is provided with a torque-accumulating roller spring 232 which is driven to rotate by a spring tensioner 233 to increase a number of working turns and accumulate torque force. When the blind fabric 27 is pulled downward by rotation of the tubular body 22, the torque-accumulating roller spring 232 is rolled up tightly. The roll-up device 23 is a conventional component and will not be described in detail herein.

The roll-up control device 24 is located at the other side of the upper rail 21, one end of the roll-up control device 24 is provided with a square shaft 241 axially connected to the other one of the two fixed brackets 25. The other end of the roll-up control device 24 is provided with a fixing shaft 242 in a hexagonal shape. The roll-up control device 24 is a conventional component and will not be described in detail herein.

The two fixed brackets 25 are respectively located at two sides of the upper rail 21 for fixing. Each of the two fixed brackets 25 includes a fixed body 251 and a vertical frame body 252. Two fixed bodies 251 are respectively located at two sides of the upper rail 21, two vertical frame bodies 252 are fixed to bottoms of the two fixed bodies 251. One end of one of the two fixed brackets 25 is provided with an adjustment wheel 253 for axially connecting and positioning the fixing column 231, allowing the torque-accumulating roller spring 232 to be rotated and adjusted to an appropriate preset number of working turns. The two fixed brackets 25 are conventional components and will not be described in detail herein.

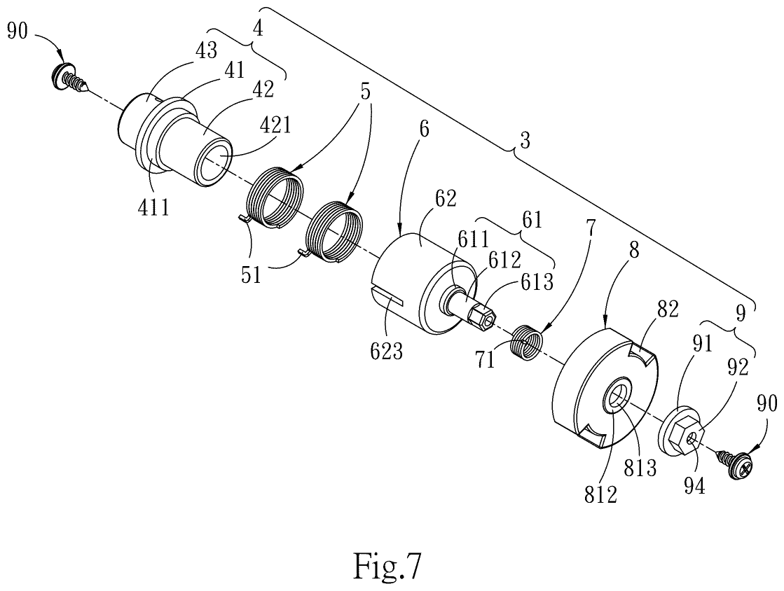

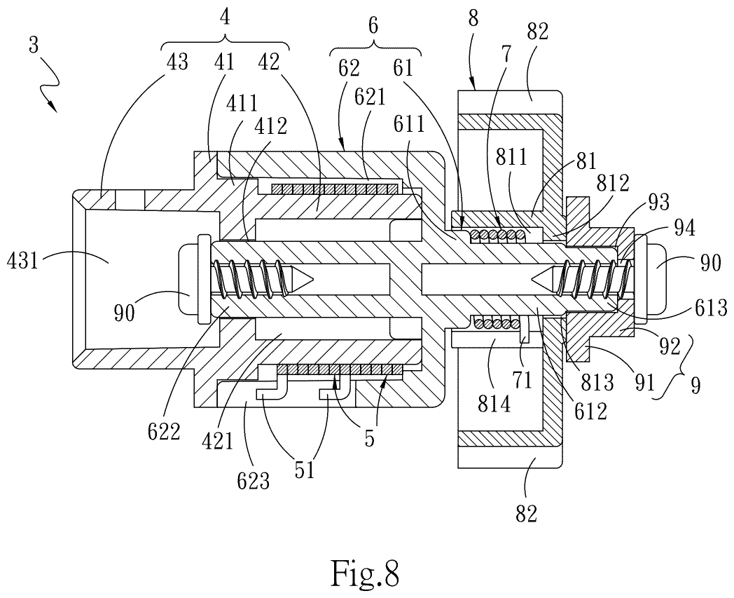

Please refer to FIG. 5, FIG. 6, FIG. 7, FIG. 8, FIG. 9A, FIG. 9B, FIG. 10A, and FIG. 10B. The roll-up auxiliary device 3 includes a main body 4, at least one first torque spring 5, a transmission body 6, at least one second torque spring 7, a drive body 8, and an axial cover 9. The at least one first torque spring 5 is sleeved on a first side of the main body 4. The transmission body 6 is sleeved on the main body 4 at the first side as the at least one first torque spring 5 and is sleeved on the at least one first torque spring 5. A first protruding end 51 of the at least one first torque spring 5 is engaged with the transmission body 6. A first side of the transmission body 6 is disposed with a shaft rod 61. The at least one second torque spring 7 is sleeved on the shaft rod 61. The drive body 8 is provided for accommodating the shaft rod 61 therein and engaged with a second protruding end 71 of the at least one second torque spring 7. The axial cover 9 is sleeved on one end of the shaft rod 61 and abuts against the drive body 8. Two fasteners 90 are respectively fixed on the axial cover 9 and the first side of the transmission body, and fixed on a second side of the transmission body 6, respectively. During pulling down the blind 2, the at least one second torque spring 7 is tightened on the shaft rod 61 to drive the transmission body 6 to rotate, the transmission body 6 drives and loosens the at least one first torque spring 5 to rotate on the main body 4 with a first resistance, and the first resistance is utilized as a balance for stop pulling down the blind 2. During pulling up the blind 2, the at least one second torque spring 7 is loosened to rotate on the shaft rod 61, the transmission body 6 tightens the at least one first torque spring 5 on the main body 4, such that the transmission body 6 do not rotate, the at least one second torque spring 7 rotates on the shaft rod 61 with a second resistance, and the second resistance is smaller than the first resistance to facilitate pulling up the blind 2.

In some embodiments, the main body includes a flange portion 41, a first protrusion 42, and a second protrusion 43. The first protrusion 42 and the second protrusion 43 are respectively disposed at two sides of the flange portion 41 and opposite to each other. The first protrusion 42 includes a first chamber 421, the second protrusion 43 includes a second chamber 431, and a step portion 411 is connected between the flange portion 41 and the first protrusion 42. The step portion 411 includes an axial hole 412 communicating with the first chamber 421 and the second chamber 431.

The at least one first torque spring 5 is sleeved on the first protrusion 42 at the first side of the main body 4. In some embodiments, a number of the at least one first torque spring 5 is two, and the two first torque springs 5 are disposed side by side.

The transmission body 6 further includes a sleeving portion 62 at the second side of the transmission body 6 and sleeved on the step portion 411. The sleeving portion 62 includes an inner space 621, a protruding shaft 622 disposed in the inner space 621, and a first slot 623 on a peripheral of the sleeving portion 62. The inner space 621 is provided for accommodating the first protrusion 42 and the at least one first torque spring 5. The protruding shaft 622 is a circular shaft and penetrates through the axial hole 412 of the step portion 411. One of the two fasteners 90 penetrates through the second chamber 431 and is fixed on the protruding shaft 622. The first slot 623 of the sleeving portion 62 is engaged with the first protruding end 51 of the at least one first torque spring 5. In one embodiment, the shaft rod 61 includes a first rod portion 611, a second rod portion 612 connected with the first rod portion 611, and a third rod portion 613 connected with the second rod portion 612, the first rod portion 611 and the second rod portion 612 are circular rods, an outer diameter of the second rod portion 612 is larger than an outer diameter of the first rod portion 611, and the third rod portion 613 is a hexagonal rod.

The at least one second torque spring 7 is sleeved on the second rod portion 612 of the shaft rod 61.

The drive body 8 includes a bushing portion 81 and at least one positioning slot 82. The bushing portion 81 includes an accommodating space 811, an inner abutting wall 812 at a bottom of the accommodating space 811, and a through hole 813. The accommodating space 811 is provided for accommodating the second rod portion 612 and the at least one second torque spring 7. The inner abutting wall 812 abuts the at least one second torque spring 7, and the through hole 813 communicates with the accommodating space 811 for the second rod portion 612 of the shaft rod 61 to penetrate therethrough. In this embodiment, an outer peripheral of the bushing portion 81 is provided with a second slot 814, and the second slot 814 is engaged with the second protruding end 71 of the at least one second torque spring 7. The at least one positioning slot is engaged with the limiting protrusion 221 of the tubular body 22 so that the tubular body 22 drives the drive body 8 to rotate along the shaft rod 61 of the transmission body 6.

The axial cover 9 includes a cover flange 91 and a cap 92 connected to the cover flange 91. The cover flange 91 and the cap 92 include a hexagonal hole 93 therein, the hexagonal hole 93 is engaged with the third rod portion 613. The cap 92 is hexagonal, and an outer diameter of the cap 92 is smaller than an outer diameter of the cover flange 91. The cap 92 includes a hole 94 communicating with the hexagonal hole 93, an inner diameter of the hole 94 is smaller than an inner diameter of the hexagonal hole 93. In this embodiment, one of the two fasteners 90 penetrates through the hole 94 of the cap 92 and is fixed on the third rod portion 613 of the shaft rod 61, and the axial cover 9 abuts the drive body 8.

Please refer to FIG. 5, FIG. 6, FIG. 7, FIG. 8, FIG. 9A, and FIG. 10A. During assembly of the blind 2, the torque-accumulating roller spring 232 is first rotated and adjusted to the appropriate preset number of working turns via the adjustment wheel 253, the torque force accumulated in the roll-up device 23 is balanced with a resistance provided by the roll-up auxiliary device 3. The roll-up auxiliary device 3 of the present invention is further configured to have the first resistance of the at least one first torque spring 5 rotating on the main body 4 when pulling down the blind 2 to be larger than the second resistance of the at least one second torque spring 7 rotating on the shaft rod 61 when pulling up the blind 2, to maintain a balance for pulling up and pulling down the blind 2.

The blind fabric 27 is then placed between the tubular body 22 and the lower rail 26. The roll-up device 23, the roll-up auxiliary device 3 and the roll-up control device 24 are disposed in the tubular body 22. The roll-up device 23 and the roll-up auxiliary device 3 are driven by the tubular body 22 to rotate, the fixing column 231 of the roll-up device 23 is axially connected to one of two fixed brackets 25, the square shaft 241 of the roll-up control device 24 is axially connected to the other one of two fixed brackets 25, thus completing the assembly of the blind 2.

Please refer to FIG. 5, FIG. 8, FIG. 9A, and FIG. 9B. When the user extends the blind fabric 27 by pulling down the lower rail 26, the drive body 8 pushes the second protruding end 71 of the at least one second torque spring 7 to be tightened through the second slot 814 of the bushing portion 81, and the at least one second torque spring 7 is fixed to the shaft rod 61 to drive the transmission body 6 to rotate. The transmission body 6 drives and loosens the at least one first torque spring 5 to rotate on the main body 4 with the first resistance, and the first resistance is utilized as a balance for stop pulling down the blind. In this embodiment, a ratio of the first resistance to the second resistance is in a range from 6:4 to 8:2.

Please refer to FIG. 5, FIG. 8, FIG. 10A, and FIG. 10B. When the user rolls up the blind fabric 27 by pulling up the lower rail 26, the drive body 8 pushes the at least one second torque spring 7 to be loosened through the second slot 814 of the bushing portion 81, such that the at least one second torque spring 7 rotates on the shaft rod 61 of the transmission body 6. During the at least one second torque spring 7 rotating on the shaft rod 61 of the transmission body 6, the transmission body 6 pushes the at least one first torque spring 5 to be tightened on the first protrusion 42 of the main body 4, such that the transmission body 6 does not rotate relative to the main body 4. The at least one second torque spring 7 rotates on the shaft rod 61 with the second resistance, and the second resistance is smaller than the first resistance to facilitate pulling up the blind fabric 27. In this embodiment, a ratio of the first resistance to the second resistance is in a range from 6:4 to 8:2.

Based on the above, compared with the existing resistance device 12, during both for pulling up and down, utilizes the spring 122 to provide a resistance, the present invention arranges the at least one second torque spring 7 to be smaller than the at least one first torque spring 5. Therefore, the first resistance of the at least one first torque spring 5 during pulling down can be larger than the resistance of the spring 122 of the existing resistance device 12, such that the blind fabric can be arranged with a longer length or a heavier material, and the second resistance of the at least one second torque spring 7 during pulling up can be smaller than the resistance of the spring 122 of the existing resistance device 12, such that the blind fabric 27 and the torque-accumulating roller spring 232 are easier to be pulled up. Thus, if the length of the blind fabric 27 is lengthened or the material thereof is heavy, the torque-accumulating roller spring 232 will not easily exceed the safety limit of working turns, which allows the torque-accumulating roller spring 232 to support the longer or heavier fabric while preventing the torque-accumulating roller spring 232 from accelerating damage due to elastic fatigue, thereby extending its lifespan.

What is claimed is:

1. A roll-up auxiliary device, for positioning a blind during pulling up or pulling down, comprising,
a main body;
at least one first torque spring, sleeved on a first side of the main body;
a transmission body, sleeved on the first side of the main body as the at least one first torque spring and sleeved on the at least one first torque spring, a first protruding end of the at least one first torque spring engaged with the transmission body, and a first side of the transmission body disposed with a shaft rod;
at least one second torque spring, sleeved on the shaft rod;
a drive body, for accommodating the shaft rod therein and engaged with a second protruding end of the at least one second torque spring;
an axial cover, sleeved on an end of the shaft rod and abutting the drive body; and
two fasteners, fixed on the axial cover and the first side of the transmission body, and fixed on a second side of the transmission body, respectively;
wherein, during pulling down the blind, the at least one second torque spring is tightened on the shaft rod to drive the transmission body to rotate, the transmission body drives and loosens the at least one first torque spring to rotate on the main body with a first resistance, and the first resistance is utilized as a balance for stop pulling down the blind, and during pulling up the blind, the at least one second torque spring is loosened to rotate on the shaft rod, the transmission body tightens the at least one first torque spring on the main body, such that the transmission body do not rotate, the at least one second torque spring rotates on the shaft rod with a second resistance, and the second resistance is smaller than the first resistance to facilitate pulling up the blind.

2. The roll-up auxiliary device as claimed in claim 1, wherein the main body comprises a flange portion, a first protrusion, and a second protrusion, the first protrusion and the second protrusion are respectively disposed at two sides of the flange portion and opposite to each other, the first protrusion comprises a first chamber, the second protrusion comprises a second chamber, a step portion is connected between the flange portion and the first protrusion, and the step portion comprises an axial hole communicating with the first chamber and the second chamber.

3. The roll-up auxiliary device as claimed in claim 2, wherein the at least one first torque spring is sleeved on the first protrusion at the first side of the main body.

4. The roll-up auxiliary device as claimed in claim 3, wherein a number of the at least one first torque spring is two, the two first torque springs are disposed side by side.

5. The roll-up auxiliary device as claimed in claim 3, wherein the transmission body further comprises a sleeving portion at the second side of the transmission body and sleeved on the step portion, the sleeving portion comprises an inner space and a first slot on a peripheral of the sleeving portion, a protruding shaft is disposed in the inner space, the inner space is provided for accommodating the first protrusion and the at least one first torque spring, the protruding shaft is a circular shaft and penetrates through the axial hole of the step portion, one of the two fasteners penetrates through the second chamber and fixed on the protruding shaft, and the first slot of the sleeving portion is engaged with the first protruding end of the at least one first torque spring.

6. The roll-up auxiliary device as claimed in claim 5, wherein the shaft rod comprises a first rod portion, a second rod portion connected with the first rod portion, and a third rod portion connected with the second rod portion, the first rod portion and the second rod portion are circular rods, an outer diameter of the second rod portion is larger than an outer diameter of the first rod portion, and the third rod portion is a hexagonal rod.

7. The roll-up auxiliary device as claimed in claim 6, wherein the at least one second torque spring is sleeved on the second rod portion of the shaft rod.

8. The roll-up auxiliary device as claimed in claim 7, wherein the drive body comprises a bushing portion and at least one positioning slot, the bushing portion comprises an accommodating space, an inner abutting wall at a bottom of the accommodating space, and a through hole, the accommodating space is provided for accommodating the second rod portion and the at least one second torque spring, the inner abutting wall abuts the at least one second torque spring, the through hole communicates with the accommodating space for the second rod portion of the shaft rod to penetrate therethrough, an outer peripheral of the bushing portion is provided with a second slot, and the second slot is engaged with the second protruding end of the at least one second torque spring.

9. The roll-up auxiliary device as claimed in claim 8, wherein the axial cover comprises a cover flange and a cap connected to the cover flange, the cover flange and the cap comprises a hexagonal hole therein, the hexagonal hole is engaged with the third rod portion, the cap is hexagonal, an outer diameter of the cap is smaller than an outer diameter of the cover flange, the cap comprises a hole communicating with the hexagonal hole, an inner diameter of the hole is smaller than an inner diameter of the hexagonal hole, one of the two fasteners penetrates through the hole of the cap and is fixed on the third rod portion of the shaft rod, and the axial cover abuts the drive body.

10. The roll-up auxiliary device as claimed in claim 1, wherein a ratio of the first resistance to the second resistance is in a range from 6:4 to 8:2.
